(19) United States
(12) Patent Application Publication
(10) Pub. No.: US 2026/0305860 A1
(43) Pub. Date: Oct. 8, 2026

(54) FOOD PROCESSING DEVICE CAPABLE OF FOOD HEATING AND SELF-CLEANING AND FOOD PROCESSING METHOD THEREOF

(71) Applicant: YO-KAI EXPRESS INC., Hayward, CA (US)

(72) Inventor: Chih Hung LIN, San Jose, CA (US)

(73) Assignee: YO-KAI EXPRESS INC., Hayward, CA (US)

(21) Appl. No.: 19/485,226

(22) PCT Filed: May 16, 2024
(86) PCT No.: PCT/US2024/029681

§ 371 Date: Nov. 17, 2025

Related U.S. Application Data
(60) Provisional application No. 63/466,786, filed on May 16, 2023.

(51) Int. Cl. A47J 27/04; A47J 36/24; G07F 17/00

(52) U.S. Cl. CPC A47J 27/04; A47J 36/24; G07F 17/0078; A47J 2027/043

(57) ABSTRACT

A food processing device capable of food heating and self-cleaning and a food processing method thereof. The food processing device includes an accommodation module, a heating tube assembly, a moving module, and a cleaning module. The accommodation module forms an accommodation space for accommodating food to be heated. The heating tube assembly is movably disposed on a side of the accommodation module. The heating tube assembly includes a first steam outlet for outputting steam to food to be heated. The moving module is connected to the heating tube assembly to drive the heating tube assembly to move along a movement route. The cleaning module is disposed on a side of the accommodation module and includes a second steam outlet disposed corresponding to the movement route of the heating tube assembly. The second steam outlet is to output steam towards the heating tube assembly to clean the heating tube assembly.

### BACKGROUND

### Technical Field

The present disclosure relates to the technical field of food processing device, particularly to a food processing device capable of food heating and self-cleaning and a food processing method thereof.

### Related Art

Nowadays, vending machines provide many kind of foods including solid foods, soups, and drinks. Foods provided by vending machines are usually to be consumed in a cold or cool state. If a consumer wants to heat the food purchased form a vending machine, an external microwave or a hot water supply is required. The flavor of food heated in a microwave may be negatively affected, especially center kind of foods such as steamed buns, dumplings, dry noodles or bread. And only limited foods such as soup and instant noodles can be prepared with hot water.

In home use, if there is food needing to be steamed, you need to prepare a pot first, add water to the pot, put the food in, separate the food from the water with a stand, and then heat the pot with a fire to turn the water in the pot into steam to heat the food. It is cost much time to steam food and is inconvenient.

### SUMMARY

The embodiments of the present disclosure provide a food processing device capable of food heating and self-cleaning and a food processing method thereof to solve issues of prior arts.

The present disclosure provides a food processing device capable of food heating and self-cleaning. The food processing device comprises an accommodation module, a heating tube assembly, a moving module, and a cleaning module. The accommodation module forms an accommodation space. The accommodation space is for accommodating food to be heated. The heating tube assembly is movably disposed on a side of the accommodation module. The heating tube assembly comprises one or more first steam outlets. The one or more first steam outlets are for outputting steam to food to be heated. The moving module is connected to the heating tube assembly to drive the heating tube assembly to move along a movement route. The cleaning module is disposed on a side of the accommodation module. The cleaning module comprises one or more second steam outlets. The one or more second steam outlets are disposed corresponding to the movement route of the heating tube assembly. The one or more second steam outlets are configured to output steam towards the heating tube assembly to clean the heating tube assembly.

In some embodiment of the present disclosure, the cleaning module further comprises an annular structure disposed corresponding to and surrounding the movement route of the heating tube assembly. The one or more second steam outlets are disposed on the annular structure.

In some embodiment of the present disclosure, the annular structure is cylindrical and comprises an annular side wall and a top wall. The top wall is connected to an end of the annular side wall. The top wall is provided with an opening. The heating tube assembly is movably disposed in the opening. The annular side wall is configured to surround the heating tube assembly while the heating tube assembly passes through the annular side wall. The one or more second steam outlets are disposed on the annular side wall.

In some embodiment of the present disclosure, the cleaning module further comprises one or more steam connectors. The one or more steam connectors are fixed on the annular side wall. An output end of each of the steam connectors is located inside the annular side wall. An input end of each of the steam connectors is located outside the annular side wall. Each of the output ends forms each of the second steam outlets, and each of the input ends is for being connected to a steam input tube.

In some embodiment of the present disclosure, the annular structure is donut-shaped and is configured to surround the heating tube assembly while the heating tube assembly passes through the annular structure. The annular structure is provided with an annular steam output channel formed inside the annular structure. The one or more second steam outlets are disposed on an inner side of the annular structure and communicated with the annular steam output channel.

In some embodiment of the present disclosure, the cleaning module further comprising a straight structure. The straight structure is provided with a straight steam output channel formed inside the straight structure. An end of the straight structure is connected to an outer surface of the annular structure, and an another end of the straight structure is for being connected to a steam input tube. The straight steam output channel is communicated with the annular steam output channel. The straight structure and the annular structure are lollipop-shaped.

In some embodiment of the present disclosure, the annular structure comprises an upper annular structure and a lower annular structure, and the upper annular structure and the lower annular structure are connected with each other. The straight structure comprises an upper straight structure and a lower straight structure, and the upper straight structure and the lower straight structure are connected with each other.

In some embodiment of the present disclosure, the upper annular structure and the upper straight structure are integrally formed, and the lower annular structure and the lower straight structure are integrally formed.

In some embodiment of the present disclosure, the one or more second steam outlets are two or more second steam outlets, and the two or more second steam outlets are arranged in an opposite or surrounding manner.

In some embodiment of the present disclosure, the accommodation module comprises a top plate and a bottom plate. The bottom plate is for carrying food to be heated, and the cleaning module is arranged on the top plate or the bottom plate.

In some embodiment of the present disclosure, the bottom plate is provided with a discharge outlet.

In some embodiment of the present disclosure, the food processing device further comprises a first collecting container. The discharge outlet is communicated with the first collecting container. The first collecting container is for containing steam or water discharged from the discharge outlet.

In some embodiment of the present disclosure, the food processing device further comprises an extraction device and an extraction channel. The extraction device is connected to the accommodation module and the extraction channel. An end of the extraction channel is communicated with the accommodation space through the extraction device, and an another end of the extraction channel is communicated with the first collecting container.

In some embodiment of the present disclosure, the food processing device further comprises a second collecting container provided on the bottom plate. The discharge outlet is disposed on a bottom end of the second collecting container. The second collecting container is for collecting steam or water and discharging the steam or water through the discharge outlet.

In some embodiment of the present disclosure, the heating tube assembly further comprises a piercing structure provided on an end of the heating tube assembly. The piercing structure is for piercing package of food to be heated.

In some embodiment of the present disclosure, the heating tube assembly further comprises a spiral track provided on an outer circumferential surface of the heating tube assembly and connected to the moving module. The moving module is configured to drive the heating tube assembly to rotate by the spiral track while driving the heating tube assembly to reciprocate along the movement route.

The present disclosure provides a food processing method according to the food processing device. The food processing method comprises: moving the heating tube assembly to contact or be adjacent to a food to be heated; outputting steam to food to be heated by the one or more first steam outlets of the heating tube assembly; moving the heating tube assembly to the cleaning module; and outputting steam towards the heating tube assembly by the one or more second steam outlets of the cleaning module to clean the heating tube assembly.

In some embodiment of the present disclosure, the steps of moving the heating tube assembly to the cleaning module and outputting steam towards the heating tube assembly by the one or more second steam outlets of the cleaning module further comprising: while moving the heating tube assembly to a predetermined height, starting to output steam towards the heating tube assembly by the one or more second steam outlets of the cleaning module.

In some embodiment of the present disclosure, the step of outputting steam towards the heating tube assembly by the one or more second steam outlets of the cleaning module further comprising: during the process of the one or more second steam outlets continuing to output steam towards the heating tube assembly, having the heating tube assembly reciprocate within a predetermined height range.

In some embodiment of the present disclosure, the step of outputting steam towards the heating tube assembly by the one or more second steam outlets of the cleaning module further comprising: continuously outputting steam towards the heating tube assembly by the one or more second steam outlets within a predetermined time range; when the predetermined time range is met, moving the heating pipe to an initial position.

In summary, based on the embodiments of the present disclosure, the food processing device and the food processing method thereof can be used to heat food with steam by the moveable heating tube assembly in a fast and convenient manner. The food heated by the food processing device and method can reserved best flavor. The discharged steam and water can be collected easily, which is beneficial of keeping the environment clean. The heating tube assembly can be cleaned by the cleaning module, meaning that the food processing device can not only used to heat food but can also clean itself. It is convenient and hygienic.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments are believed to be novel, and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of a food processing device of the first embodiment of the present disclosure;

FIG. 2 is a cross-sectional, perspective view of a food processing device of the first embodiment of the present disclosure;

FIG. 3 is an exploded view of a heating tube assembly and a cleaning module of a food processing device of the first embodiment of the present disclosure;

FIG. 4 is a perspective view of a food processing device of the second embodiment of the present disclosure;

FIG. 5 is a cross-sectional, perspective view of a food processing device of the second embodiment of the present disclosure, in which the heating tube assembly reaches a predetermined height;

FIG. 6 is a cross-sectional, perspective view of a food processing device of the second embodiment of the present disclosure, in which the heating tube assembly reaches a lowest height within a predetermined height range;

FIG. 7 is a perspective view of a heating tube assembly, a cleaning module and a second collecting container of a food processing device of the second embodiment of the present disclosure;

FIG. 8 is a cross-sectional, perspective view of a heating tube assembly, a cleaning module and a second collecting container of a food processing device of the second embodiment of the present disclosure;

FIG. 9 is an exploded view of a cleaning module of a food processing device of the second embodiment of the present disclosure; and

FIG. 10 is a flow chart of a food processing method of embodiments of the present disclosure.

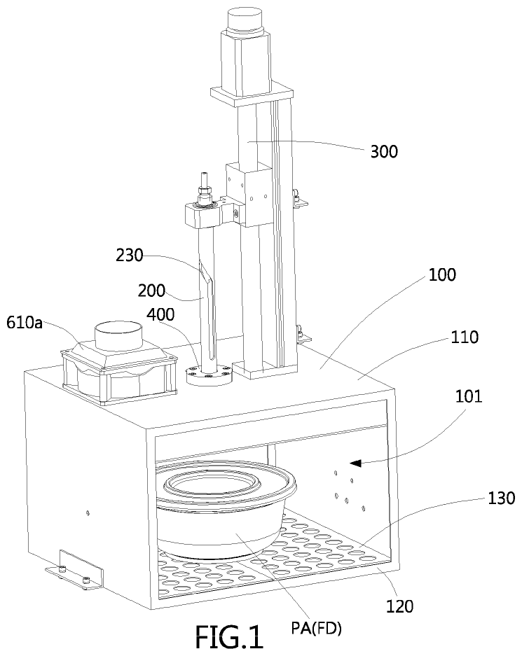

Reference numbers of elements of FIG. 1 to FIG. 9 are: food processing device 10a, 10b, accommodation module 100, accommodation space 101, top plate 110, bottom plate 120, discharge outlet 121, mesh plate 130, heating tube assembly 200, first steam outlet 210, piercing structure 220, spiral track 230, moving module 300, cleaning module 400, second steam outlet 410, annular structure 420a, 420b, annular side wall 421, top wall 422, opening 423, annular steam output channel 424, lower part of annular steam output channel 424lo, upper annular structure 425, lower annular structure 426, steam connector 430, output end 431, input end 432, straight structure 440, straight steam output channel 441, lower part of straight steam output channel 441lo, upper straight structure 442, lower straight structure 443, steam connector 450, steam input tube 460, first collecting container 500, extraction device 610a, 610b, extraction channel 620, second collecting container 700, steep slope wall 710, gentle slope wall 720, food FD, package PA, movement route MR.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description disclosed some embodiments of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

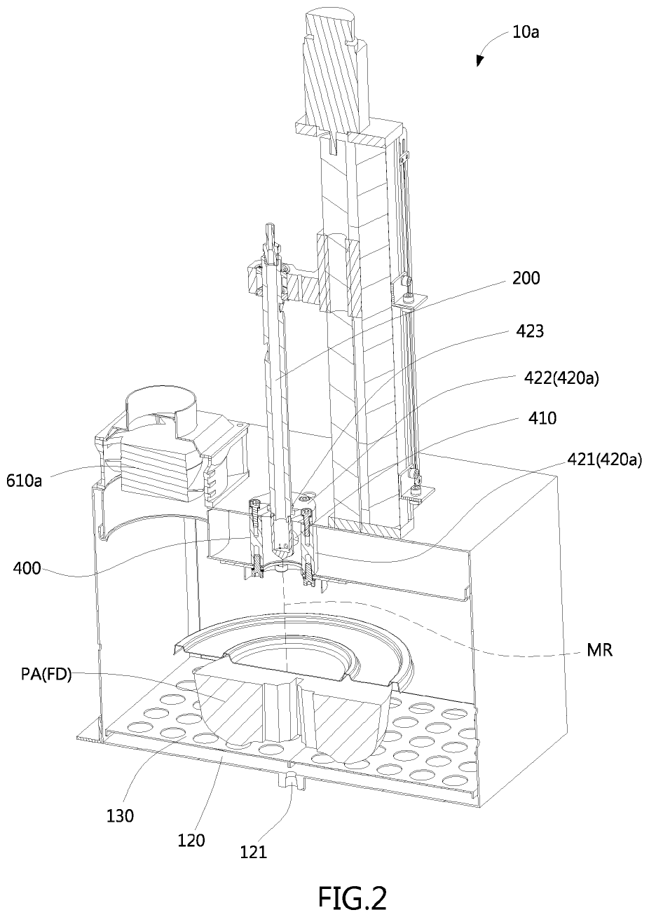

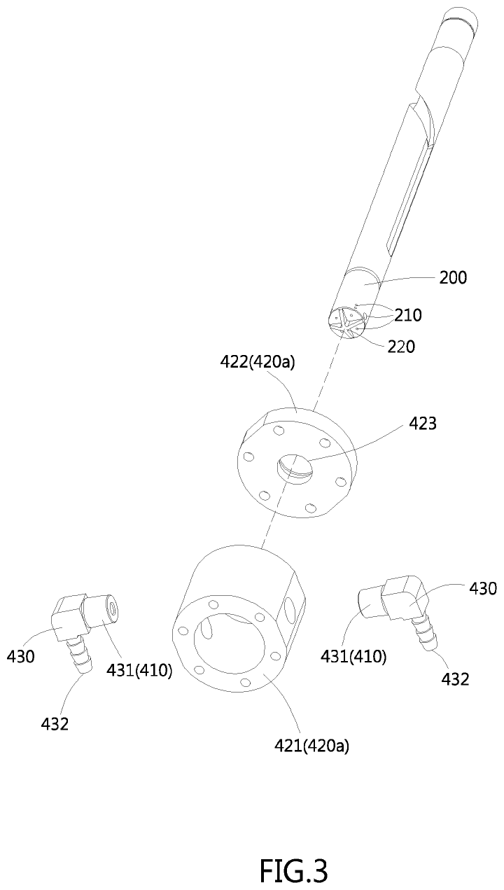

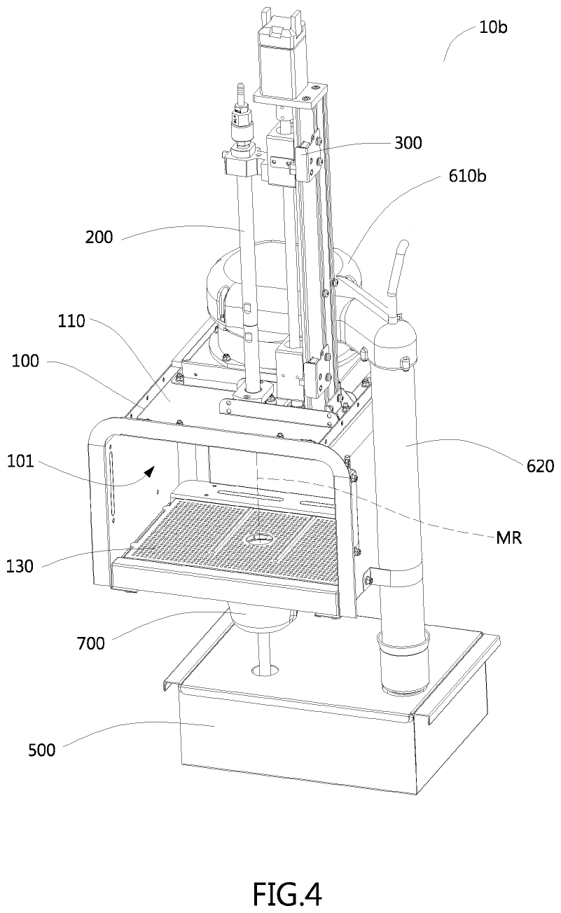

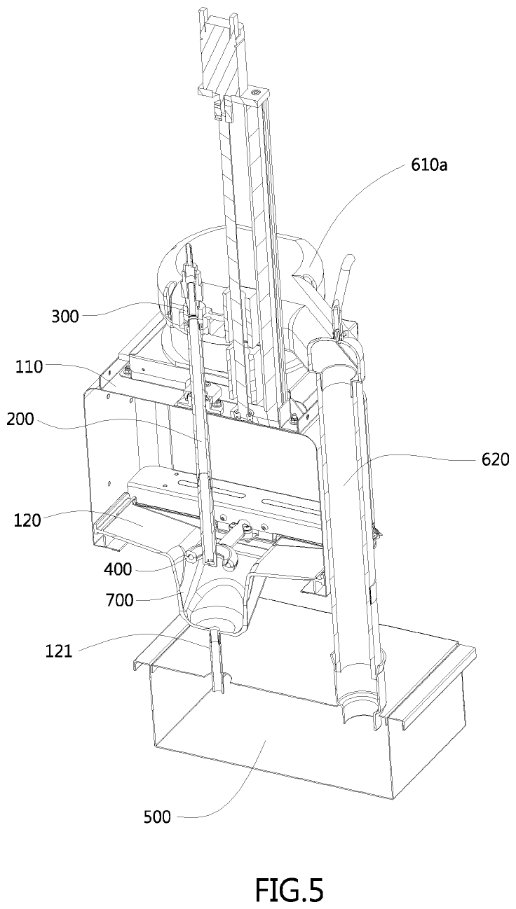

Referring to FIG. 1 to FIG. 5, FIG. 1 is a perspective view of a food processing device 10a of the first embodiment of the present disclosure; FIG. 2 is a cross-sectional, perspective view of a food processing device 10a of the first embodiment of the present disclosure; FIG. 3 is an exploded view of a heating tube assembly 200 and a cleaning module 400 of a food processing device 10a of the first embodiment of the present disclosure; FIG. 4 is a perspective view of a food processing device 10b of the second embodiment of the present disclosure; and FIG. 5 is a cross-sectional, perspective view of a food processing device 10b of the second embodiment of the present disclosure, in which the heating tube assembly 200 reaches a predetermined height. The present disclosure provides a food processing device 10a and 10b capable of food heating and self-cleaning. In some embodiments, the food processing device 10a and 10b may be built in a vending machine, e.g., the food processing device 10a and 10b is a part of the vending machine; alternatively, the food processing device 10a and 10b may be a vending machine itself. In some embodiments, the food processing device 10a and 10b may be built to be a stand alone machine for home use or commercial use.

In the first and second embodiment, the food processing device 10a and 10b comprises an accommodation module 100, a heating tube assembly 200, a moving module 300, and a cleaning module 400. The accommodation module 100 forms an accommodation space 101. The accommodation space 101 is for accommodating food to be heated. The food to be heated can be manually placed by user. For example, a user takes a food wanted to be heated from refrigerator and puts it into the accommodation space 101. Alternatively, the food to be heated can be automatically placed by the food processing device 10a and 10b. For example, the food processing device 10a and 10b belongs to a part of vending machine which includes a food storage module and a transferring module. While a user selects and purchases a food on an interface of the vending machine, the transferring module transfers the selected food from the food storage module to the accommodation space 101.

The heating tube assembly 200 is movably disposed on a side of the accommodation module 100. The heating tube assembly 200 comprises one or more first steam outlets 210. The one or more first steam outlets 210 are for outputting steam to food to be heated. The heating tube assembly 200 may be communicated with a steam generator to receive steam and output steam through the one or more first steam outlets 210. The moving module 300 is connected to the heating tube assembly 200 to drive the heating tube assembly 200 to move along a movement route MR (as shown in FIG. 2 and FIG. 4). For example, the moving module 300 includes a guiding track, a holder on the guiding track, and a motor connected to the holder. The holder holds the heating tube assembly 200, and the motor drives the holder along with the heating tube assembly 200 to move along the guiding track. The movement of the heating tube assembly 200 guided by the holder and the guiding track and driven by the motor defines the movement route MR.

As shown in FIG. 1, in some embodiments, the heating tube assembly 200 further comprises a spiral track 230 provided on an outer circumferential surface of the heating tube assembly 200. The spiral track 230 may be connected to the moving module 300. The moving module 300 is configured to drive the heating tube assembly 200 to rotate by the spiral track 230 while driving the heating tube assembly 200 to reciprocate along the movement route MR.

As shown in FIG. 3, the first steam outlets 210 are plural. Some of the first steam outlets 210 are provided on the surface of a bottom end of the heating tube assembly 200, and some of the first steam outlets 210 are provided on a circumferential surface of the heating tube assembly 200 near to the bottom end thereof. The heating tube assembly 200 further comprises a piercing structure 220 provided on the bottom end of the heating tube assembly 200. The piercing structure 220 is for piercing package of food to be heated.

As shown in FIG. 1 and FIG. 2, the food FD is packaged in a package PA. The heating tube assembly 200 may be moved by the moving module 300 from an initial/upper position to a heating/lower position, such that the heating tube assembly 200 may pierce through the package PA by the piercing structure 220 to insert into the package PA. Then the steam may be outputted from the first steam outlets 210. The steam may be filled in the package PA to heat the food FD inside the package PA. After the heating process is completed, the heating tube assembly 200 is moved backward to the initial position.

As shown in FIG. 1 and FIG. 2, the cleaning module 400 is disposed on a side of the accommodation module 100. In the embodiment, the cleaning module 400 and the heating tube assembly 200 are disposed on the same side of accommodation module 100. In particular, the cleaning module 400 is on an upper side of the accommodation module 100 corresponding to the initial position of the heating tube assembly 200. The cleaning module 400 comprises one or more second steam outlets 410. The one or more second steam outlets 410 are disposed corresponding to the movement route MR of the heating tube assembly 200. The one or more second steam outlets 410 are configured to output steam towards the heating tube assembly 200 to clean the heating tube assembly 200.

As shown in FIG. 2 and FIG. 3, the cleaning module 400 further comprises an annular structure 420a disposed corresponding to the movement route MR of the heating tube assembly 200, and the annular structure 420a surrounds the movement route MR of the heating tube assembly 200. The one or more second steam outlets 410 are disposed on the annular structure 420a. While the heating tube assembly 200 passes through the cleaning module 400 along the movement route MR, the annular structure 420a surrounds the heating tube assembly 200, and the one or more second steam outlets 410 face towards the heating tube assembly 200.

In some embodiments, after the heating process is completed, the heating tube assembly 200 is moved backward to the initial position, and the food FD is removed from the accommodation space 101, the cleaning module 400 may be triggered automatically or manually to start to clean the heating tube assembly 200. Steam for cleaning may be outputted from the one or more second steam outlets 410 facing towards the heating tube assembly 200 to clean the heating tube assembly 200. In some embodiments, steam for cleaning may be outputted from the second steam outlets 410 in certain pressure generated by a motor. The heating tube assembly 200 can be cleaned efficiently by steam with heat and pressure.

As shown in FIG. 2 and FIG. 3, in the first embodiment, the annular structure 420a is cylindrical and the annular structure 420a comprises an annular side wall 421 and a top wall 422. The top wall 422 is connected to an end of the annular side wall 421. The top wall 422 is provided with an opening 423. The heating tube assembly 200 is movably disposed in the opening 423. The annular side wall 421 is configured to surround the heating tube assembly 200 while the heating tube assembly 200 passes through the annular side wall 421. The second steam outlets 410 are disposed on the annular side wall 421 inwardly and the second steam outlets 410 face towards the heating tube assembly 200.

In some embodiments, the cleaning module 400 further comprises one or more steam connectors 430. The one or more steam connectors 430 are fixed on the annular side wall 421. As shown in FIG. 3, in the first embodiment, there are two steam connectors 430 provided on the annular side wall 421. Each of the steam connectors 430 comprises an output end 431 and an input end 432. The output end 431 of the steam connector 430 is located inside the annular side wall 421. In some embodiments, the output end 431 of the steam connector 430 is aligned with the inner surface of the annular side wall 421. The input end 432 of the steam connector 430 is located outside the annular side wall 421. Each of the output ends 431 forms the corresponding one of the second steam outlets 410. Each of the input ends 432 is for being connected to a steam input tube which may be communicated with a steam generator 430.

In some embodiments, the one or more second steam outlets 410 are two or more second steam outlets 410, and the two or more second steam outlets 410 are arranged in an opposite or surrounding manner. In the first embodiment, the cleaning module 400 comprises two second steam outlets 410, and the two second steam outlets 410 are arranged oppositely. Accordingly, the cleaning module 400 comprises two steam connectors 430 which respectively form the two second steam outlets 410. In some embodiments, three or more second steam outlets 410 may be provided and arranged in a surrounding manner.

As shown in FIG. 1 and FIG. 2, in the first embodiment, the food processing device 10a further comprises an extraction device 610a. The extraction device 610a is connected to the accommodation module 100. The extraction device 610a may extract the steam or air from the accommodation module 100.

As shown in FIG. 1, FIG. 2, FIG. 4, and FIG. 5, in the first and second embodiments, the accommodation module 100 comprises a top plate 110 and a bottom plate 120. The bottom plate 120 is for carrying food to be heated, and the cleaning module 400 is arranged on the top plate 110 or the bottom plate 120. The bottom plate 120 is provided with a discharge outlet 121. The steam and water can be discharged through the discharge outlet 121. In the first embodiment, as shown in FIG. 1 and FIG. 2, the cleaning module 400 is arranged on the top plate 110. In the second embodiment, as shown in FIG. 4 and FIG. 5, the cleaning module 400 is arranged on the bottom plate 120.

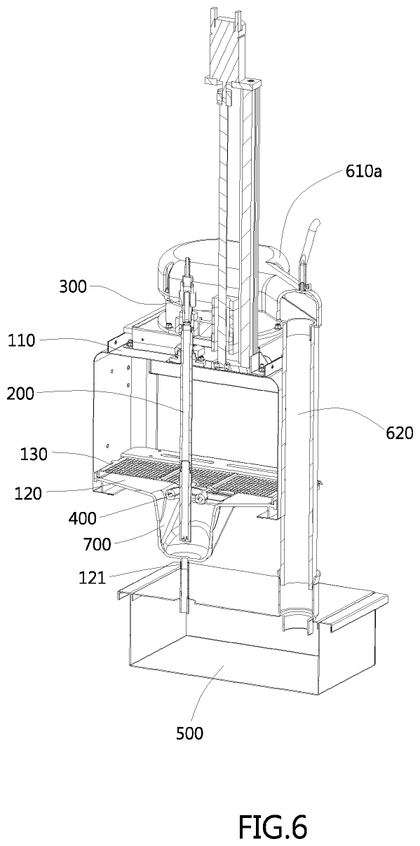

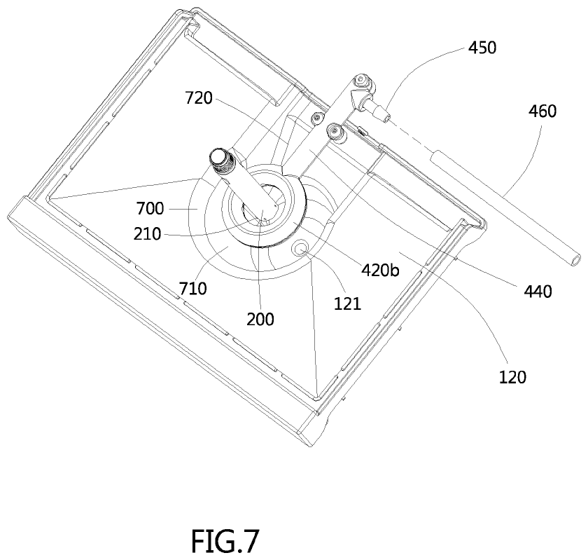

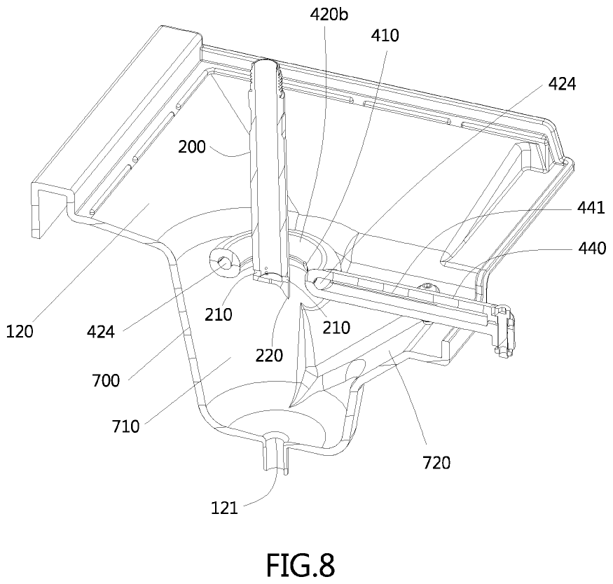

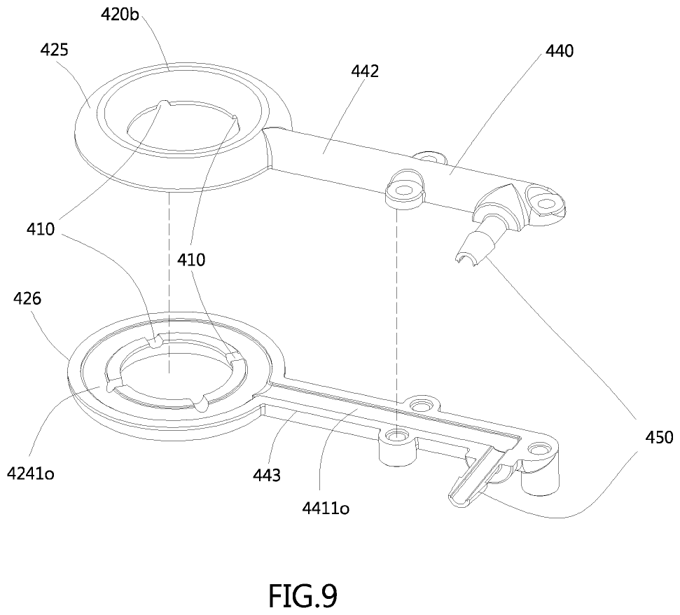

Referring to FIG. 6 to FIG. 9, FIG. 6 is a cross-sectional, perspective view of a food processing device 10b of the second embodiment of the present disclosure, in which the heating tube assembly 200 reaches a lowest height within a predetermined height range; FIG. 7 is a perspective view of a heating tube assembly 200, a cleaning module 400 and a second collecting container 700 of a food processing device 10b of the second embodiment of the present disclosure; FIG. 8 is a cross-sectional, perspective view of a heating tube assembly 200, a cleaning module 400 and a second collecting container 700 of a food processing device 10b of the second embodiment of the present disclosure; and FIG. 9 is an exploded view of a cleaning module 400 of a food processing device 10b of the second embodiment of the present disclosure.

As shown in FIG. 1, FIG. 2, and FIG. 6, in some embodiments, the accommodation module 100 further comprises a mesh plate 130. The mesh plate 130 is positioned above the bottom plate 120. The food FD can be placed on the mesh plate 130. The steam or water may pass through the mesh plate 130 and discharged from the discharge outlet 121. As shown in FIG. 1 and FIG. 2, in the first embodiment, the cleaning module 400 is disposed above the bottom plate 120 and the mesh plate 130. In particular, the accommodation space 101 is between the cleaning module 400 and the mesh plate 130 in the first embodiment. As shown in FIG. 6, in the second embodiment, the cleaning module 400 is disposed above the bottom plate 120 and below the mesh plate 130. The heat tube assembly may pass through the mesh plate 130 to reach the cleaning module 400.

As shown in FIG. 5 to FIG. 9, in the second embodiment, the annular structure 420b is donut-shaped. The annular structure 420b is disposed corresponding to the movement route MR of the heating tube assembly 200. Additionally, the annular structure 420b surrounds the movement route MR of the heating tube assembly 200. The annular structure 420b is configured to surround the heating tube assembly 200 while the heating tube assembly 200 passes through the annular structure 420b. While the heating tube assembly 200 passes through the cleaning module 400 along the movement route MR, the annular structure 420b surrounds the heating tube assembly 200, and the one or more second steam outlets 410 face towards the heating tube assembly 200.

As shown in FIG. 8 and FIG. 9, the annular structure 420b is provided with an annular steam output channel 424 formed inside the annular structure 420b. As shown in FIG. 7, FIG. 8 and FIG. 9, the one or more second steam outlets 410 are disposed on an inner side of the annular structure 420b and communicated with the annular steam output channel 424.

As shown in FIG. 7, FIG. 8 and FIG. 9, in the second embodiment, the cleaning module 400 further comprises a straight structure 440. An end of the straight structure 440 is connected to an outer side of the annular structure 420b, and an another end of the straight structure 440 is for being connected to a steam input tube 460. As shown in FIG. 8 and FIG. 9, the straight structure 440 is provided with a straight steam output channel 441 formed inside the straight structure 440. The straight steam output channel 441 is communicated with the annular steam output channel 424. The straight structure 440 and the annular structure 420b are lollipop-shaped.

As shown in FIG. 8 and FIG. 9, in the second embodiment, the annular structure 420b comprises an upper annular structure 425 and a lower annular structure 426. The upper annular structure 425 and the lower annular structure 426 are connected with each other to form the annular structure 420b. The straight structure 440 comprises an upper straight structure 442 and a lower straight structure 443, and the upper straight structure 442 and the lower straight structure 443 are connected with each other to form the straight structure 440. In some embodiments, the upper annular structure 425 and the upper straight structure 442 are integrally formed, and the lower annular structure 426 and the lower straight structure 443 are integrally formed.

As shown in FIG. 9, in the second embodiment, the lower annular structure 426 is provided with a lower part of annular steam output channel 42410; similarly, the upper annular structure 425 is provided with an upper part of annular steam output channel (not shown). The lower part of annular steam output channel 424lo and the upper part of annular steam output channel jointly form the annular steam output channel 424 while the upper annular structure 425 and the lower annular structure 426 are connected with each other. The lower straight structure 443 is provided with a lower part of straight steam output channel 441lo; similarly, the upper straight structure 442 is provided with an upper part of straight steam output channel (not shown). The lower part of straight steam output channel 441lo and the upper part of straight steam output channel jointly form the straight steam output channel 441 while the upper straight structure 442 and the lower straight structure 443 are connected with each other.

As shown in FIG. 7 and FIG. 9, in the second embodiment, the cleaning module 400 comprises a steam connector 450. The steam connector 450 is provided on the another end of the straight structure 440 away from the annular structure 420b. The steam connector 450 is connected to a steam input tube 460 which may be communicated with a steam generator. In some embodiments, the steam connector 450 is integrally formed with the straight structure 440. As shown in FIG. 9, In some embodiments, the steam connector 450 is integrally formed with the upper straight structure 442 and the lower straight structure 443, respectively.

As shown in FIG. 4 and FIG. 5, in some embodiments, the food processing device 10b further comprises a first collecting container 500. The discharge outlet 121 is communicated with the first collecting container 500. The first collecting container 500 is for containing steam or water discharged from the discharge outlet 121.

As shown in FIG. 4 and FIG. 5, in the second embodiment, the food processing device 10b further comprises an extraction device 610b and an extraction channel 620. The extraction device 610b is connected to the accommodation module 100 and the extraction channel 620. An end of the extraction channel 620 is communicated with the accommodation space 101 through the extraction device 610b, and an another end of the extraction channel 620 is communicated with the first collecting container 500. The extraction device 610b may extract the steam or air from the accommodation space 101 and discharge the steam, air, or condensate water to the first collecting container 500 through the extraction channel 620.

As shown in FIG. 4 to FIG. 8, in some embodiments, the food processing device 10b further comprises a second collecting container 700 provided on the bottom plate 120. The discharge outlet 121 is disposed on a bottom end of the second collecting container 700. The second collecting container 700 is for collecting steam or water and discharging the steam or water through the discharge outlet 121. As shown in FIG. 5 and FIG. 6, in the second embodiment, the second collecting container 700 is communicated with the first collecting container 500 through the discharge outlet 121.

As shown in FIG. 7 and FIG. 8, in the second embodiment, the second collecting container 700 comprises a steep slope wall 710 and a gentle slope wall 720. The slope of the steep slope wall 710 is greater than that of the gentle slope wall 720. The annular structure 420b is above the steep slope wall 710. The straight structure 440 is above the gentle slope wall 720.

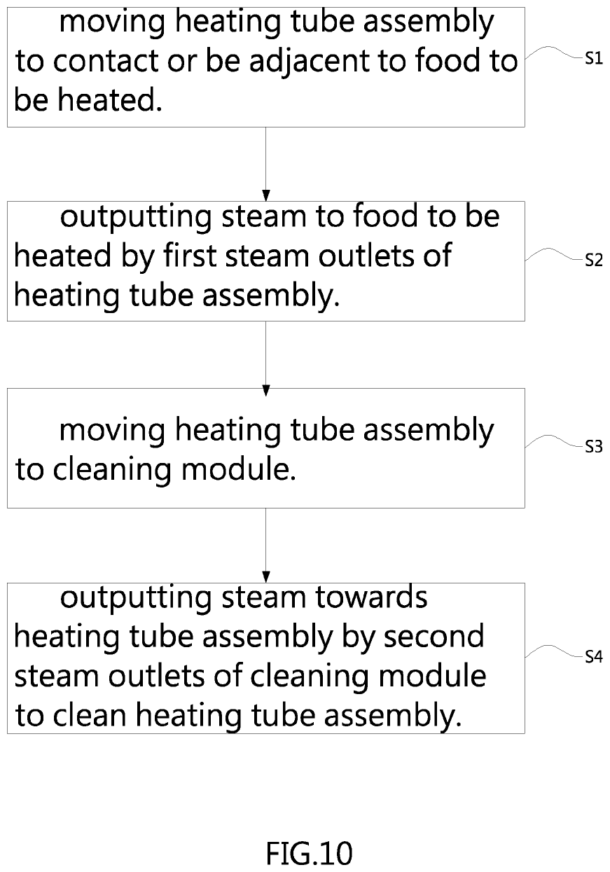

Referring to FIG. 10, FIG. 10 is a flow chart of a food processing method of embodiments of the present disclosure. In some embodiments, the food processing method is, but not limited to, based on the food processing device 10a, 10b as shown in FIG. 1 to FIG. 9. The food processing method comprises: step S1: moving the heating tube assembly 200 to contact or be adjacent to a food to be heated; step S2: outputting steam to food to be heated by the one or more first steam outlets 210 of the heating tube assembly 200; step S3: moving the heating tube assembly 200 to the cleaning module 400; and step S4: outputting steam towards the heating tube assembly 200 by the one or more second steam outlets 410 of the cleaning module 400 to clean the heating tube assembly 200.

In some embodiments, the steps S3 and S4 of moving the heating tube assembly 200 to the cleaning module 400 and outputting steam towards the heating tube assembly 200 by the second steam outlets 410 of the cleaning module 400 further comprises: while moving the heating tube assembly 200 to a predetermined height, starting to output steam towards the heating tube assembly 200 by the one or more second steam outlets 410 of the cleaning module 400. In some embodiments, after the heating process of the step S2 of outputting steam to heat the food FD by the one or more first steam outlets 210 of the heating tube assembly 200 is completed, the heating tube assembly 200 is moved backward to the initial position, and the food FD can be removed automatically by certain mechanism in the vending machine or can be removed manually by user. In the first embodiment, the predetermined height may be, but not limited to, refer to the aforementioned initial position, as shown in FIG. 2, and the cleaning module 400 may be triggered automatically or manually to start to clean the heating tube assembly 200 while the heating tube assembly 200 reaches the initial position and the food is detected to be removed from the accommodation space 101. In the second embodiment, the predetermined height may be, but not limited to, refer to the position of the heating tube assembly 200 shown in FIG. 5, and the cleaning module 400 may be triggered automatically or manually to start to clean the heating tube assembly 200 while the heating tube assembly 200 reaches the position shown in FIG. 5.

In some embodiments, the step S4 of outputting steam towards the heating tube assembly 200 by the second steam outlets 410 of the cleaning module 400 further comprises: during the process of the one or more second steam outlets 410 continuing to output steam towards the heating tube assembly 200, having the heating tube assembly 200 reciprocate within a predetermined height range. As shown in FIG. 5 and FIG. 6, the predetermined height range may be, but not limited to, refer a range between the highest position (highest height) shown in FIG. 5 and the lowest position (lowest height) shown in FIG. 6. For example, during the cleaning process of cleaning the heating tube assembly 200, the heating tube assembly 200 may be controlled by the food processing device 10b to reciprocate within the predetermined height range as shown in FIG. 5 and FIG. 6.

In some embodiments, the step S4 of outputting steam towards the heating tube assembly 200 by the second steam outlets 410 of the cleaning module 400 further comprises: continuously outputting steam towards the heating tube assembly 200 by the second steam outlets 410 within a predetermined time range; when the predetermined time range is met, moving the heating pipe to an initial position. For example, the cleaning process of cleaning the heating tube assembly 200 may be last 5 seconds while the predetermined time range is set to be 0-5 seconds; then the heating tube assembly 200 may be moved back to the initial position while the predetermined time range is met, which means the cleaning process has been last 5 seconds. The heating tube assembly 200 may stay still, reciprocate, or perform a combination of moving still and reciprocating within the predetermined time range while cleaning.

Based on the embodiments of the present disclosure, the food processing device and the food processing method thereof can be used to heat food with steam by the moveable heating tube assembly in a fast and convenient manner. The food heated by the food processing device and method can reserved best flavor. The discharged steam and water can be collected easily, which is beneficial of keeping the environment clean. The heating tube assembly can be cleaned by the cleaning module 400. The cleaning module 400 can clean the heating tube assembly through steam to ensure the cleaning and disinfection of the heating tube assembly. The food processing device and the food processing method of embodiments of the present disclosure can not only used to heat food so as to reserve better flavor but can also clean and disinfect by itself. It is convenient and hygienic.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A food processing device capable of food heating and self-cleaning, comprising:
an accommodation module forming an accommodation space, wherein the accommodation space is for accommodating food to be heated;
a heating tube assembly movably disposed on a side of the accommodation module, the heating tube assembly comprising one or more first steam outlets, wherein the one or more first steam outlets are for outputting steam to food to be heated;
a moving module connected to the heating tube assembly to drive the heating tube assembly to move along a movement route; and
a cleaning module disposed on a side of the accommodation module, the cleaning module comprising one or more second steam outlets, wherein the one or more second steam outlets are disposed corresponding to the movement route of the heating tube assembly, the one or more second steam outlets are configured to output steam towards the heating tube assembly to clean the heating tube assembly.

2. The food processing device of claim 1, wherein the cleaning module further comprises an annular structure disposed corresponding to and surrounding the movement route of the heating tube assembly, and the one or more second steam outlets are disposed on the annular structure.

3. The food processing device of claim 2, wherein the annular structure is cylindrical and comprises an annular side wall and a top wall, the top wall is connected to an end of the annular side wall, the top wall is provided with an opening, the heating tube assembly is movably disposed in the opening, the annular side wall is configured to surround the heating tube assembly while the heating tube assembly passes through the annular side wall, and the one or more second steam outlets are disposed on the annular side wall.

4. The food processing device of claim 3, wherein the cleaning module further comprises one or more steam connectors, the one or more steam connectors are fixed on the annular side wall, an output end of each of the steam connectors is located inside the annular side wall, an input end of each of the steam connectors is located outside the annular side wall, each of the output ends forms each of the second steam outlets, and each of the input ends is for being connected to a steam input tube.

5. The food processing device of claim 2, wherein the annular structure is donut-shaped and is configured to surround the heating tube assembly while the heating tube assembly passes through the annular structure, the annular structure is provided with an annular steam output channel formed inside the annular structure, the one or more second steam outlets are disposed on an inner side of the annular structure and communicated with the annular steam output channel.

6. The food processing device of claim 5, wherein the cleaning module further comprising a straight structure, the straight structure is provided with a straight steam output channel formed inside the straight structure, an end of the straight structure is connected to an outer side of the annular structure, an another end of the straight structure is for being connected to a steam input tube, the straight steam output channel is communicated with the annular steam output channel, and the straight structure and the annular structure are lollipop-shaped.

7. The food processing device of claim 6, wherein the annular structure comprises an upper annular structure and a lower annular structure, and the upper annular structure and the lower annular structure are connected with each other; wherein the straight structure comprises an upper straight structure and a lower straight structure, and the upper straight structure and the lower straight structure are connected with each other.

8. The food processing device of claim 7, wherein the upper annular structure and the upper straight structure are integrally formed, and the lower annular structure and the lower straight structure are integrally formed.

9. The food processing device of claim 1, wherein the one or more second steam outlets are two or more second steam outlets, and the two or more second steam outlets are arranged in an opposite or surrounding manner.

10. The food processing device of claim 1, wherein the accommodation module comprises a top plate and a bottom plate, the bottom plate is for carrying food to be heated, and the cleaning module is arranged on the top plate or the bottom plate.

11. The food processing device of claim 10, wherein the bottom plate is provided with a discharge outlet.

12. The food processing device of claim 11, further comprising a first collecting container, wherein the discharge outlet is communicated with the first collecting container, and the first collecting container is for containing steam or water discharged from the discharge outlet.

13. The food processing device of claim 12, further comprising an extraction device and an extraction channel, the extraction device is connected to the accommodation module and the extraction channel, an end of the extraction channel is communicated with the accommodation space through the extraction device, and an another end of the extraction channel is communicated with the first collecting container.

14. The food processing device of claim 11, further comprising a second collecting container provided on the bottom plate, wherein the discharge outlet is disposed on a bottom end of the second collecting container, and the second collecting container is for collecting steam or water and discharging the steam or water through the discharge outlet.

15. The food processing device of claim 1, wherein the heating tube assembly further comprises a piercing structure provided on an end of the heating tube assembly, and the piercing structure is for piercing package of food to be heated.

16. The food processing device of claim 1, wherein the heating tube assembly further comprises a spiral track provided on an outer circumferential surface of the heating tube assembly and connected to the moving module, and the moving module is configured to drive the heating tube assembly to rotate by the spiral track while driving the heating tube assembly to reciprocate along the movement route.

17. A food processing method according to the food processing device of claim 1, comprising:
moving the heating tube assembly to contact or be adjacent to a food to be heated;
outputting steam to food to be heated by the one or more first steam outlets of the heating tube assembly;
moving the heating tube assembly to the cleaning module; and
outputting steam towards the heating tube assembly by the one or more second steam outlets of the cleaning module to clean the heating tube assembly.

18. The food processing method of claim 17, wherein the steps of moving the heating tube assembly to the cleaning module and outputting steam towards the heating tube assembly by the one or more second steam outlets of the cleaning module further comprising: while moving the heating tube assembly to a predetermined height, starting to output steam towards the heating tube assembly by the one or more second steam outlets of the cleaning module.

19. The food processing method of claim 18, wherein the step of outputting steam towards the heating tube assembly by the one or more second steam outlets of the cleaning module further comprising: during the process of the one or more second steam outlets continuing to output steam towards the heating tube assembly, having the heating tube assembly reciprocate within a predetermined height range.

20. The food processing method of claim 18, wherein the step of outputting steam towards the heating tube assembly by the one or more second steam outlets of the cleaning module further comprising: continuously outputting steam towards the heating tube assembly by the one or more second steam outlets within a predetermined time range; when the predetermined time range is met, moving the heating pipe to an initial position.
